(19) United States
(12) Patent Application Publication
(10) Pub. No.: US 2014/0120403 A1
(43) Pub. Date: May 1, 2014

(54) BATTERY SEPARATOR AND METHOD FOR PREPARING THE SAME

(71) Applicants: Miaoyun Lin, Guangdong (CN); Zhen You, Guangdong (CN); Weicheng Yu, Guangdong (CN); Mingjun Luo, Guangdong (CN); Huiquan Liu, Guangdong (CN)

(72) Inventors: Miaoyun Lin, Guangdong (CN); Zhen You, Guangdong (CN); Weicheng Yu, Guangdong (CN); Mingjun Luo, Guangdong (CN); Huiquan Liu, Guangdong (CN)

(73) Assignees: BYD Company Limited, Guangdong, CN (unknown); Shenzhen BTD Auto R&D Company Limited, Guangdong (CN)

(21) Appl. No.: 14/124,199

(22) PCT Filed: Jun. 6, 2012
(86) PCT No.: PCT/CN2012/076542

§ 371 Date: Dec. 5, 2013

(30) Foreign Application Priority Data
Jun. 10, 2011 (CN) 201110155574.2

(51) Int. Cl. H01M 2/16

(52) U.S. Cl. CPC H01M 2/1686; H01M 2/162
USPC 429/145; 429/144; 427/58

(57) ABSTRACT

A battery separator and a method for preparing the same are provided. The battery separator comprises: a substrate which is a polyvinylidene fluoride non-woven fabric; and a coating layer formed on each surface of the substrate, in which the material of the coating layer comprises an ultra-high molecular weight polyethylene and a linear low density polyethylene.

### CROSS-REFERENCE TO RELATED APPLICATION

This application claims priority to and benefits of Chinese Patent Application Serial No. 201110155574.2, filed with the State Intellectual Property Office of P. R. China on Jun. 10, 2011, the entire content of which is incorporated herein by reference.

### FIELD

The present disclosure relates to a battery separator, and more particularly to a battery separator and a method for preparing the same.

### BACKGROUND

A Li-ion secondary battery is a battery with very high energy density, however, explosion risks caused by short circuit of the battery may occur. In the Li-ion secondary battery, a separator not only needs to conduct Li-ions, but also needs to separate a positive electrode from a negative electrode in order to prevent short circuit between the positive and negative electrodes and self-discharge inside the battery to a certain degree. Therefore, the performances such as thermal stability, safety, permeability, porosity and thickness of the separator may affect the performance of the battery largely.

Recently, the Li-ion secondary battery has been used in various fields such as the field of hybrid electric vehicles, and consequently requirements for thermal stability which the separator needs to meet becomes stricter and stricter. This is because poor thermal stability of the separator will result in explosion of the battery caused by overheating of the battery and melting and rupture of the separator. The thermal stability of the separator in the battery depends on the pore closing temperature and the separator rupture temperature. In order to ensure the thermal stability of the separator, the separator needs to have low pore closing temperature and high separator rupture temperature. Currently, in order to enhance the thermal stability of the separator, a conventional method of adding an inorganic material or a heat-resistant resin to a polyethylene is used. However, in this method, the compatibility between a filler and the polyethylene is poor, the separator is difficult to prepare, and the strength of the obtained separator is low. In addition, compared with a small battery, the requirements of a power battery for the permeability of the separator are higher. This is because poor permeability will result in large internal resistance of the battery, which may not supply enough energy to an electric vehicle. The permeability of the polyolefin separator prepared by a currently used wet method and a currently used dry method is poor, which may not meet the requirements of the power battery.

It has been reported that a polyvinylidene fluoride non-woven fabric is used as a battery separator. This non-woven fabric is also called nonwovens, is constituted by oriented or random fibers, is a new generation of environmentally friendly materials, and has properties of moisture resistance, air permeability, flexibility, light weight, no combustion supporting, easy decomposition, non-toxic property and nonirritant, rich colors, low price, recyclablility, etc. Because the polyvinylidene fluoride non-woven fabric has the appearance and certain performances of a cloth, the polyvinylidene fluoride non-woven fabric is referred to as a cloth. As the battery separator, the polyvinylidene fluoride non-woven fabric may enhance the air permeability and the high-temperature separator rupture temperature of the separator, however, the pore closing temperature of the polyvinylidene fluoride non-woven fabric is too high, which may generally reach up to about 150° C. However, in order to prevent the explosion of the battery caused by overheating of the battery, the requirements of the power battery for the pore closing temperature of the separator are generally high, and the pore closing temperature of the separator generally needs to be below about 135° C. Therefore, the battery separator which is merely constituted by the polyvinylidene fluoride non-woven fabric may not meet the requirements of the power battery. Meanwhile, because the polyvinylidene fluoride non-woven fabric has too large porosity and nonuniform pore size distribution, there are a few of large pores, which may cause certain potential safety risks of the battery. Moreover, if the battery separator is merely constituted by the polyvinylidene fluoride non-woven fabric, the puncture strength and the tensile strength of the battery separator are lower, which may still not meet the requirements of the power battery for the performance of the separator.

### SUMMARY

Embodiments of the present disclosure seek to solve at least one of the problems existing in the prior art to at least some extent, particularly problems of unsatisfactory air permeability and unsatisfactory high-temperature separator rupture temperature of a conventional battery separator as well as too high pore closing temperature, lower puncture strength and lower tensile strength of a polyvinylidene fluoride non-woven fabric separator, or to provide a consumer with a useful commercial choice.

According to embodiments of a first broad aspect of the present disclosure, there is provided a battery separator. The battery separator comprises: a substrate which is a polyvinylidene fluoride non-woven fabric; and a coating layer formed on each surface of the substrate, in which the material of the coating layer comprises an ultra-high molecular weight polyethylene and a linear low density polyethylene.

According to embodiments of a second broad aspect of the present disclosure, there is provided a method for preparing a battery separator. The method comprises steps of:

(a) mixing an ultra-high molecular weight polyethylene, a linear low density polyethylene with a second solvent to obtain a second mixture, and heating and stirring the second mixture to obtain a mixed solution;

(b) coating the mixed solution onto both surfaces of a polyvinylidene fluoride non-woven fabric to obtain a coated film;

(c) stretching the coated film to obtain a stretched film; and

(d) heat setting the stretched film to obtain the battery separator,

in which the second solvent is a good solvent for a polyolefin. The good solvent for the polyolefin refers to a solvent having a polarity similar to that of the polyolefin and may better dissolve the polyolefin according to the similar dissolve mutually theory.

It has been unexpectedly found by the inventors that by coating a mixture of an ultra-high molecular weight polyethylene and a linear low density polyethylene onto both surfaces of a polyvinylidene fluoride non-woven fabric, the pore size distribution on the surface of the obtained separator may be more uniform, and the obtained separator may have higher air permeability, significantly reduced pore closing temperature, significantly enhanced puncture strength and significantly enhanced separator rupture temperature, thus enhancing the safety of a battery. The reasons are supposed as follows. The porosity of the separator coated with the mixture of the ultra-high molecular weight polyethylene and the linear low density polyethylene is about 40% to about 80%, and the separator with higher porosity may have higher air permeability. Meanwhile, because the melting point of the polyvinylidene fluoride is up to about 170° C. so as to provide a higher separator rupture temperature to the separator, and the melting point of the coated polyolefin is about 135° C. so as to provide a lower pore closing temperature to the separator, so that the separator may have higher separator rupture temperature and lower pore closing temperature simultaneously. In addition, because a conventional non-woven fabric separator is formed by a continuous one-step method comprising yarn spreading and hot pressing coiling, the orientation degree of the obtained non-woven fabric fibers is low, the adhesive strength between fibers is low, and the tensile strength and the puncture strength of the obtained non-woven fabric separator are low. However, by coating the ultra-high molecular weight polyethylene and the linear low density polyethylene onto both surfaces of the polyvinylidene fluoride non-woven fabric, after the ultra-high molecular weight polyethylene and the linear low density polyethylene are stretched and oriented, the mechanical strength is significantly enhanced, so that the puncture strength and the separator rupture temperature of the obtained separator may be significantly enhanced.

Additional aspects and advantages of embodiments of present disclosure will be given in part in the following descriptions, become apparent in part from the following descriptions, or be learned from the practice of the embodiments of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. In addition, terms such as “first” and “second” are used herein for purposes of description and are not intended to indicate or imply relative importance or significance.

According to an embodiment of the present disclosure, a battery separator is provided. The battery separator comprises: a substrate which is a polyvinylidene fluoride non-woven fabric; and a coating layer formed on each surface of the substrate, in which the material of the coating layer comprises an ultra-high molecular weight polyethylene and a linear low density polyethylene.

In the battery separator according to an embodiment of the present disclosure, preferably, based on the total weight of the coating layer, the amount of the ultra-high molecular weight polyethylene is about 12 wt % to about 97 wt %, and the amount of the linear low density polyethylene is about 3 wt % to about 88 wt %. More preferably, based on the total weight of the coating layer, the amount of the ultra-high molecular weight polyethylene is about 50 wt % to about 88 wt %, and the amount of the linear low density polyethylene is about 12 wt % to about 50 wt %. Therefore, the ultra-high molecular weight polyethylene and the linear low density polyethylene may be dissolved more uniformly, and the adhesive strength between the coating layer and the substrate is higher.

In the battery separator according to an embodiment of the present disclosure, preferably, the weight average molecular weight of the ultra-high molecular weight polyethylene is about 1×10⁶ to about 7×10⁶, the molecular weight distribution of the ultra-high molecular weight polyethylene is about 3 to about 30, the weight average molecular weight of the linear low density polyethylene is about 1×10⁴ to about 8×10⁴, and the molecular weight distribution of the linear low density polyethylene is about 1.5 to about 5. More preferably, the weight average molecular weight of the ultra-high molecular weight polyethylene is about 2×10⁶ to about 4×10⁶, the molecular weight distribution of the ultra-high molecular weight polyethylene is about 5 to about 15, the weight average molecular weight of the linear low density polyethylene is about 2×10⁴ to about 5×10⁴, and the molecular weight distribution of the linear low density polyethylene is about 1.8 to about 3. Therefore, the ultra-high molecular weight polyethylene and the linear low density polyethylene may be dissolved more uniformly, and the coating layer may have high viscosity and consequently may be adhered to the substrate more easily.

In the battery separator according to an embodiment of the present disclosure, preferably, the thickness of the coating layer is about 4 μm to about 12 μm. More preferably, the thickness of the coating layer is about 5 μm to about 8 μm. Therefore, the coating layer may allow the separator to have better air permeability while improving the uniform pore size distribution of the polyvinylidene fluoride non-woven fabric and the strength of the separator to the largest extent.

In the battery separator according to an embodiment of the present disclosure, preferably, the thickness of the polyvinylidene fluoride non-woven fabric is about 12 μm to about 25 μm. More preferably, the thickness of the polyvinylidene fluoride non-woven fabric is about 15 μm to about 20 μm. Therefore, the polyvinylidene fluoride non-woven fabric may have enough high strength and better air permeability.

In the battery separator according to an embodiment of the present disclosure, the weight average molecular weight of the polyvinylidene fluoride non-woven fabric is preferably about 2×10⁵ to about 8×10⁵, more preferably about 3×10⁵ to about 6×10⁵, and the molecular weight distribution of the polyvinylidene fluoride non-woven fabric is preferably about 2 to about 5, more preferably about 2.2 to about 3.5. Therefore, the polyvinylidene fluoride may be dissolved uniformly and have suitable viscosity, beads in the obtained polyvinylidene fluoride non-woven fabric may be as few as possible, and the puncture strength and the tensile strength of the polyvinylidene fluoride non-woven fabric may be enhanced.

In the battery separator according to an embodiment of the present disclosure, the mesh diameter of the polyvinylidene fluoride non-woven fabric is preferably about 50 nm to about 900 nm, more preferably about 60 nm to about 400 nm. Therefore, the air permeability of the battery separator may be better improved while ensuring that no defects appear in the separator.

In the battery separator according to an embodiment of the present disclosure, the porosity of the polyvinylidene fluoride non-woven fabric is preferably about 50% to about 80%, more preferably about 55% to about 75%. Therefore, enough high adhesive strength between fibers may be ensured while ensuring enough high air permeability of the separator, thus enhancing the strength of the battery separator.

According to an embodiment of the present disclosure, a method for preparing a battery separator is provided. The method comprises steps of:

(a) mixing an ultra-high molecular weight polyethylene, a linear low density polyethylene with a second solvent to obtain a second mixture, and heating and stirring the second mixture to obtain a mixed solution;

(b) coating the mixed solution onto both surfaces of a polyvinylidene fluoride non-woven fabric to obtain a coated film;

(c) stretching the coated film to obtain a stretched film; and

(d) heat setting the stretched film to obtain the battery separator,

in which the second solvent is a good solvent for a polyolefin, which refers to a solvent having a polarity similar to that of the polyolefin. Preferably, the second solvent is at least one selected from a group consisting of decalin, coal oils, benzene, toluene, chloroform, diethyl ether, trichloroethylene, paraffins and liquid paraffins.

In the method for preparing the battery separator according to an embodiment of the present disclosure, preferably, in step (a), based on the total weight of the mixed solution, the amount of the ultra-high molecular weight polyethylene is about 1 wt % to about 15 wt %, the amount of the linear low density polyethylene is about 0.5 wt % to about 8 wt %, and the amount of the second solvent is about 75 wt % to about 99 wt %. More preferably, based on the total weight of the mixed solution, the amount of the ultra-high molecular weight polyethylene is about 3 wt % to about 8 wt %, the amount of the linear low density polyethylene is about 1 wt % to about 3 wt %, and the amount of the second solvent is about 85 wt % to about 96 wt %. Therefore, the ultra-high molecular weight polyethylene and the linear low density polyethylene may be dissolved more uniformly, and the adhesive strength between the coating layer and the substrate is higher.

In the method for preparing the battery separator according to an embodiment of the present disclosure, preferably, in step (b), the operating speed of a coater is about 1 m/min to about 10 m/min, and the thickness of a coating layer formed on each surface of the substrate by coating the mixed solution of the ultra-high molecular weight polyethylene and the linear low density polyethylene is about 4 μm to about 12 μm. More preferably, the operating speed of the coater is about 1.5 m/min to about 4 m/min. Therefore, the production efficiency may be further enhanced while ensuring that the coating layer is adhered to the substrate in time.

In the method for preparing the battery separator according to an embodiment of the present disclosure, preferably, in step (c), stretching the coated film may comprise first stretching and then extracting, or may comprise low-temperature stretching and high-temperature stretching, in which low-temperature stretching is used for phase separation.

Preferably, during the first stretching and then extracting, the stretching temperature of first stretching is about 80° C. to about 130° C.; the area stretching ratio of first stretching is about 2 to about 16; an extractant is at least one selected from the group consisting of n-hexane, heptane, octane or methylene chloride; and after extraction, the residual rate of the solvents in the extracted film may be not greater than 5%. More preferably, during the first stretching and then extracting, the stretching temperature of first stretching is about 90° C. to about 120° C.; the area stretching ratio of first stretching is about 3 to about 12; the extractant is at least one selected from the group consisting of n-hexane, heptane, octane or methylene chloride; and after extraction, the residual rate of the solvents in the extracted film may be not greater than 1%. Therefore, the performances such as air permeability, tensile strength, puncture strength and separator rupture temperature may be further enhanced.

More preferably, stretching the coated film may comprise low-temperature stretching and high-temperature stretching. First, low-temperature stretching is performed to subject the ultra-high molecular weight polyethylene, the linear low density polyethylene and the second solvent to phase separation, the stretching temperature of low-temperature stretching is about 10° C. to about 60° C., and the area stretching ratio of low-temperature stretching is about 1.2 to about 4. After low-temperature stretching, high-temperature stretching is performed to evaporate the second solvent fully, the stretching temperature of high-temperature stretching is about 80° C. to about 125° C., and the area stretching ratio of high-temperature stretching is about 2 to about 8. More preferably, the stretching temperature of low-temperature stretching is about 20° C. to about 40° C., and the area stretching ratio of low-temperature stretching is about 1.5 to about 3, thus enhancing phase separation effects between the second solvent and the ultra-high molecular weight polyethylene and between the second solvent and the linear low density polyethylene. More preferably, the stretching temperature of high-temperature stretching is about 90° C. to about 110° C., and the area stretching ratio of high-temperature stretching is about 3 to about 7, so that the second solvent may be evaporated more fully and the separator may have higher puncture strength and higher tensile strength.

In the method for preparing the battery separator according to an embodiment of the present disclosure, preferably, step (d) comprises:

(d1) radiation crosslinking the stretched film to obtain a radiated film; and

(d2) heat setting the radiated film to obtain the battery separator.

More preferably, in step (d1), a sensitizer is added during the radiation crosslinking, and the sensitizer is at least one selected from a group consisting of silicon dichloride, carbon tetrachloride, trimethylolpropane trimethacrylate, trimethylolpropane triacrylate and triallyl isocyanurate.

Under ray radiation, under the action of the sensitizer, several free radicals will be formed on molecular chains of the polyolefin and the polyvinylidene fluoride, and the free radicals may crosslink two or more linear molecules. Radiation crosslinking of the polyvinylidene fluoride non-woven fabric and the coating layer may result in high adhesive strength between the coating layer and the polyvinylidene fluoride non-woven fabric.

More preferably, in step (d1), a ray used during the radiation crosslinking is at least one selected from a group consisting of a λ ray, an x ray and an electron beam, and the dose of the ray is about 100 kGy to about 400 kGy. More preferably, the dose of the ray is about 200 kGy to about 300 kGy. Therefore, more active free radicals may participate in crosslinking, and degradation of the polyolefin and the polyvinylidene fluoride may be avoided.

In the method for preparing the battery separator according to an embodiment of the present disclosure, preferably, in step (d2), the heat setting temperature is about 100° C. to about 140° C. The heat setting comprises micro-stretching. The area stretching ratio of micro-stretching is about 1 to about 5. More preferably, the heat setting temperature may be about 120° C. to about 130° C., and the area stretching ratio of micro-stretching may be about 1.2 to about 2.

In the method for preparing the battery separator according to an embodiment of the present disclosure, the polyvinylidene fluoride non-woven fabric may be directly commercially available, or may be obtained by:

(s1) placing a polyvinylidene fluoride in a first solvent to obtain a first mixture, and heating and stirring the first mixture to obtain a polyvinylidene fluoride spinning solution; and

(s2) placing the polyvinylidene fluoride spinning solution in a high-voltage electrostatic spinning device for spinning to obtain the polyvinylidene fluoride non-woven fabric,

in which the first solvent is a good solvent for polyvinylidene fluoride. The good solvent for polyvinylidene fluoride is mainly used to be mixed with the polyvinylidene fluoride so as to form a spinning solution with certain electrical conductivity. Preferably, the first solvent is at least one selected from a group consisting of N, N-dimethylformamide, N-methylpyrrolidone, acetone, dimethylacetamide, dimethyl sulfoxide and tetrahydrofuran.

In the method for preparing the battery separator according to an embodiment of the present disclosure, preferably, in step (s1), after placing the polyvinylidene fluoride in the first solvent to obtain the first mixture and heating and stirring the first mixture, the first mixture is subjected to ultrasonic deaeration treatment, so that the obtained fibers may have better continuity. During the ultrasonic deaeration treatment, various methods well known to those skilled in the art may be used, for example, a vacuum deaeration method, a static deaeration method, a high-temperature deaeration method or an ultrasonic deaeration method.

In the method for preparing the battery separator according to an embodiment of the present disclosure, preferably, in step (s1), based on the total weight of the polyvinylidene fluoride spinning solution, the amount of the polyvinylidene fluoride is about 3 wt % to about 30 wt %, and the amount of the first solvent is about 70 wt % to about 98 wt %. More preferably, based on the total weight of the polyvinylidene fluoride spinning solution, the amount of the polyvinylidene fluoride is about 8 wt % to about 20 wt %, and the amount of the first solvent is about 80 wt % to about 90 wt %. Therefore, the spinning solution may flow more uniformly under the electric field force, the efflux of the charged spinning solution may be more stable, and the obtained fibers may be more continuous and may be distributed more uniformly.

In the method for preparing the battery separator according to an embodiment of the present disclosure, preferably, in step (s1), the heating temperature is about 30° C. to about 80° C., the stirring rate is about 10 r/min to about 500 r/min, and the heating time is about 0.1 h to about 4 h. More preferably, the heating temperature is about 45° C. to about 70° C., the stirring rate is about 30 r/min to about 200 r/min, and the heating time is about 0.5 h to about 2 h. Therefore, oxidative degradation of the polyvinylidene fluoride and generation of air bubbles may be reduced, so that the polyvinylidene fluoride may be dispersed in the first solvent more uniformly.

In the method for preparing the battery separator according to an embodiment of the present disclosure, particularly, step (s2) is as follows. The polyvinylidene fluoride spinning solution obtained in step (s1) is injected into a three-way tube in a spinning device, a spinning port is connected with a positive output terminal of a high-voltage power supply, a negative output terminal is connected with a metal receiving plate, the high-voltage power supply is turned on for preheating for about 30 min, the distance between the spinning port and the metal receiving plate is adjusted, and then spinning is started. The polyvinylidene fluoride spinning solution forms small spinning streams in the air after ejected from the spinning port, and moves to the metal receiving plate in a high-speed irregular spiral trajectory. Because of evaporation of the first solvent, the small spinning streams are solidified and fall on the metal receiving plate to form fiber aggregates similar to a non-woven fabric, and then the fiber aggregates are reinforced and compacted to form the polyvinylidene fluoride non-woven fabric.

In the method for preparing the battery separator according to an embodiment of the present disclosure, preferably, in step (s2), the spinning voltage is about 1KV to about 80KV, more preferably about 7KV to about 30KV, most preferably about 8KV to about 15KV. While increasing the voltage and the electric field intensity and ensuring that the fibers are thinner and more uniform, aggregation and adhesion of the fibers may be avoided, which are resulted from the fact that the voltage is too high, the acceleration rate of the efflux of the spinning solution is too high, there are too many ‘wet’ yarns accumulated on the metal receiving plate in a short time, and the first solvent does not have enough time to evaporate. Preferably, the distance between the spinning port and the metal receiving plate is about 5 cm to about 30 cm, more preferably about 10 cm to about 18 cm. Therefore, the first solvent in the ‘wet’ yarns accumulated on the metal receiving plate may be completely evaporated, and it may be ensured that the spinning solution may be completely ejected onto the metal receiving plate, so that the formed polyvinylidene fluoride non-woven fabric may be more regular and have better thickness uniformity.

Examples of the present disclosure will be described below to further illustrate the present disclosure.

### Example 1

The separator in this example is obtained by the following steps.

(s1) 4 kg of a polyvinylidene fluoride with a weight average molecular weight of about 3.7×10⁵ and a molecular weight distribution of 2.4 was mixed with 32 kg of N, N-dimethylformamide and 4 kg of acetone to obtain a first mixture. The first mixture was added into a stirring tank. At a stirring rate of about 50 r/min, the temperature was increased to about 60° C. The first mixture was heated and stirred at about 60° C. for about 1 h and ultrasonic deaerated, followed by standing for 2 h to obtain a polyvinylidene fluoride spinning solution.

(s2) The polyvinylidene fluoride spinning solution obtained in step (s1) was injected into a three-way tube in a high-voltage electrostatic spinning device, a spinning port was connected with a positive output terminal of a high-voltage power supply, a negative output terminal was connected with a metal receiving plate, the high-voltage power supply was turned on at a spinning voltage of about 13KV for preheating for about 30 min, the distance between the spinning port and the metal receiving plate was adjusted to be about 15 cm, spinning was started to form fiber aggregates similar to a non-woven fabric, and then the fiber aggregates were reinforced and compacted to form a polyvinylidene fluoride non-woven fabric.

The diameter of the obtained polyvinylidene fluoride fibers on the metal receiving plate was about 50 nm to about 200 nm, the mesh diameter of the polyvinylidene fluoride non-woven fabric was about 80 nm to about 300 nm, the thickness of the polyvinylidene fluoride non-woven fabric was about 16 μm, and the porosity of the polyvinylidene fluoride non-woven fabric was about 70%.

(a) 2 kg of an ultra-high molecular weight polyethylene with a weight average molecular weight of about 3.9×10⁶ and a molecular weight distribution of about 5.3 and 0.4 kg of a linear low density polyethylene with a weight average molecular weight of about 4×10⁴ and a molecular weight distribution of about 2 were mixed with 37.6 kg of decalin to obtain a second mixture. The second mixture was added into a stirring tank. At a stirring rate of about 50 r/min, the temperature was increased to about 135° C. The second mixture was heated and stirred at about 135° C. for about 2 h to obtain a mixed solution.

(b) The mixed solution obtained in step (a) was coated onto both surfaces of the polyvinylidene fluoride non-woven fabric obtained in step (s2) to obtain a coated film. Therefore, a coating layer was formed on each surface of the polyvinylidene fluoride non-woven fabric. The operating speed of a coater was about 2 m/min, and the thickness of the coating layer was about 7 μm.

(c) The coated film obtained in step (b) was stretched to obtain a stretched film. First, low-temperature stretching was performed at a stretching temperature of about 30° C. with an area stretching ratio of about 3, and then high-temperature stretching was performed at a stretching temperature of about 105° C. with an area stretching ratio of about 5.

(d1) The stretched film was radiation crosslinked to obtain a radiated film, so that the coating layer may better adhere to the polyvinylidene fluoride non-woven fabric.

(d2) The stretched film was heat set at a temperature of about 124° C. to obtain the battery separator. The area stretching ratio of micro-stretching was about 1.2.

The obtained separator is recorded as S1.

### Example 2

This example is different from Example 1 in that: in step (s2), the spinning voltage was about 20KV, and the thickness of the obtained polyvinylidene fluoride non-woven fabric was about 26 μm. The obtained separator is recorded as S2.

### Example 3

This example is different from Example 1 in that: in step (s1), 8 kg of the polyvinylidene fluoride was mixed with 28 kg of N, N-dimethylformamide and 4 kg of acetone. The obtained separator is recorded as S3.

### Example 4

This example is different from Example 1 in that: in step (s2), the spinning voltage was about 5KV, the distance between the spinning port and the metal receiving plate was about 5 cm, the diameter of the obtained polyvinylidene fluoride fibers was about 40 nm to about 500 nm, the mesh diameter of the polyvinylidene fluoride non-woven fabric was about 50 nm to about 400 nm, and the porosity of the polyvinylidene fluoride non-woven fabric was about 60%. The obtained separator is recorded as S4.

### Example 5

This example is different from Example 1 in that: in step (a), 6 kg of the ultra-high molecular weight polyethylene and 1.2 kg of the linear low density polyethylene were mixed with 32.8 kg of decalin. The obtained separator is recorded as S5.

### Example 6

This example is different from Example 1 in that: in step (a), 0.8 kg of the ultra-high molecular weight polyethylene and 1.6 kg of the linear low density polyethylene were mixed with 37.6 kg of decalin. The obtained separator is recorded as S6.

### Example 7

This example is different from Example 1 in that: in step (a), 2.35 kg of the ultra-high molecular weight polyethylene and 0.05 kg of the linear low density polyethylene were mixed with 37.6 kg of decalin. The obtained separator is recorded as S7.

### Example 8

This example is different from Example 1 in that: in step (b), the operating speed of the coater was about 5 m/min, and the thickness of the coating layer was about 12 μm. The obtained separator is recorded as S8.

### Example 9

This example is different from Example 1 in that: in step (c), the stretching temperature of low-temperature stretching was about 20° C., and the stretching temperature of high-temperature stretching was about 90° C. The obtained separator is recorded as S9.

### Example 10

This example is different from Example 1 in that: step (d1) was not performed, that is, the stretched film was not radiation crosslinked. The obtained separator is recorded as S10.

### Example 11

This example is different from Example 1 in that: in step (a), 2 kg of the ultra-high molecular weight polyethylene and 0.4 kg of the linear low density polyethylene were mixed with 37.6 kg of liquid paraffins; and in step (c), the coated film was merely subjected to one stretching at a stretching temperature of about 120° C. with an area stretching ratio of about 6, the stretched film was extracted with n-hexane, the residual rate of the solvents in the extracted film was about 0.5%, the extracted film was dried at a drying temperature of about 80° C. The obtained separator is recorded as S11.

### Comparative Example 1

This example is different from Example 1 in that: the polyvinylidene fluoride non-woven fabric was not coated. The obtained separator is recorded as D1.

### Comparative Example 2

This example is different from Example 1 in that: a vinylidene fluoride-hexafluoropropylene copolymer non-woven fabric was prepared by high-voltage electrostatic spinning. The diameter of the prepared vinylidene fluoride-hexafluoropropylene copolymer fibers was about 300 nm to about 500 nm, the mesh diameter of the vinylidene fluoride-hexafluoropropylene copolymer non-woven fabric was about 500 nm to about 800 nm, the thickness of the vinylidene fluoride-hexafluoropropylene copolymer non-woven fabric was about 30 μm, and the porosity of the vinylidene fluoride-hexafluoropropylene copolymer non-woven fabric was about 70%. The vinylidene fluoride-hexafluoropropylene copolymer non-woven fabric was not coated to obtain a separator D2.

Performance Test

The following performances of the obtained separators S1-S11 and D1-D2 will be tested.

(1) Air Permeability

Using a 4110 type Gurley air permeability tester, according to the GB/T5402-2003 test standard, under conditions of an average pressure difference of about 1.23 kPa and a compressed area of the separator inside a cylinder of about 6.42 cm², based on the time for which air with a volume of about 100 ml passed through the separator, air permeability of the separators S1-S11 and D1-D2 was tested.

(2) Puncture Strength

A puncture instrument was used to test the puncture strength of the separators S1-S11 and D1-D2. Particularly, each of the separators S1-S11 and D1-D2 was vertically pierced using a slick pin with a diameter of about 1 mm at a speed of about 2 m/min, and the results were recorded by a FCN-5B type data recorder.

(3) Thermal Shrinkage Percent

According to the GB/T12027-2004/ISO 11501:1995 test standard, a 100 mm×100 mm region on each of the 120 mm×120 mm separators S1-S11 and D1-D2 was marked, each of the separators S1-S11 and D1-D2 was spread in an oven and coated with a layer of preheated kaolin, the temperature in the oven was about 90° C., and the heating time was 2 h. Then, each sample was taken out and maintained at room temperature for about 30 min. Before each sample was tested again, a 100 mm×100 mm region was marked. The thermal shrinkage percent was calculated according to a formula: ΔT=(T−T0)/T0×100%, where T is the length of a marked region after heating, T₀ is the initial length of the marked region, and the thermal shrinkage percent is the absolute value of ΔT.

(4) Separator Rupture Temperature

Each of the separators S1-S11 and D1-D2 was placed in a simulation battery, each of the positive and negative electrodes of the simulation battery was made from a stainless steel sheet, the volume of an electrolyte in the simulation battery was about 1.0 ml to about 1.2 ml, and the contact area between each separator and the electrolyte was about 6.42 cm². The simulation battery was gradually heated from about 30° C. to about 200° C. When the resistance of the simulation battery suddenly drops for the first time, if the resistance difference is greater than about 50 ohms, the temperature at which the resistance suddenly drops is the separator rupture temperature.

The above performance test results of the separators S1-S11 and D1-D2 are all converted into performance test results of the separators S1-S11 and D1-D2 each having a thickness of 25 μm. The converted test results are shown in Table 1.

TABLE 1

| | Performance | | | | |
|---|---|---|---|---|---|
| | | | Thermal | Pore | Separator |
| | | | Shrinkage | Closing | Rupture |
| | Air | Puncture | Percent | Tem- | Tem- |
| | Permeability | Strength | (90° C./ | perature | perature |
| Example | (s/100 ml) | (kgf) | 2 h) | (° C.) | (° C.) |
| Example 1 | 268 | 0.9 | 1.2% | 131 | 171 |
| Example 2 | 235 | 0.6 | 1.0% | 131 | 172 |
| Example 3 | 315 | 0.7 | 1.1% | 131 | 171 |
| Example 4 | 328 | 0.8 | 1.1% | 131 | 170 |
| Example 5 | 330 | 1.0 | 1.2% | 130 | 172 |
| Example 6 | 280 | 0.8 | 1.2% | 129 | 171 |
| Example 7 | 300 | 0.9 | 1.3% | 132 | 171 |
| Example 8 | 342 | 0.8 | 1.4% | 131 | 170 |
| Example 9 | 280 | 0.7 | 1.1% | 131 | 171 |
| Example 10 | 270 | 0.7 | 1.3% | 131 | 168 |
| Example 11 | 330 | 0.7 | 1.3% | 132 | 170 |
| Comparative | 105 | 0.2 | 1.1% | 157 | 166 |
| Example 1 | | | | | |
| Comparative | 85 | 0.2 | 1.3% | 145 | 155 |
| Example 2 | | | | | |

It may be seen from Table 1 that compared with Comparative Embodiment 1 and Comparative Embodiment 2, with the separator prepared by the method according to an embodiment of the present disclosure, the air permeability is higher, however, the air permeability of the separators in Comparative Embodiments 1-2 is lower, which indicated that the pore size of the separators in Comparative Embodiments 1-2 is too large or there are defects in the separators in Comparative Embodiments 1-2 so as to cause risks of direct contact of positive and negative electrodes. Moreover, compared with the separators in Comparative Embodiments 1-2, the separator according to an embodiment of the present disclosure has significantly reduced pore closing temperature, significantly enhanced puncture strength, significantly enhanced separator rupture temperature, and smaller thermal shrinkage percent, thus enhancing the safety of a battery.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

1. A battery separator, comprising:
a substrate which is a polyvinylidene fluoride non-woven fabric; and
a coating layer formed on each surface of the substrate
wherein the coating layer comprises an ultra-high molecular weight polyethylene and a linear low density polyethylene.

2. The battery separator of claim 1, wherein based on the total weight of the coating layer, the amount of the ultra-high molecular weight polyethylene is about 12 wt % to about 97 wt %, and the amount of the linear low density polyethylene is about 3 wt % to about 88 wt %.

3. The battery separator of claim 1, wherein the weight average molecular weight of the ultra-high molecular weight polyethylene is about 1×10⁶ to about 7×10⁶, the molecular weight distribution of the ultra-high molecular weight polyethylene is about 3 to about 30, the weight average molecular weight of the linear low density polyethylene is about 1×10⁴ to about 8×10⁴, and the molecular weight distribution of the linear low density polyethylene is about 1.5 to about 5.

4. The battery separator of claim 1, wherein the thickness of the coating layer is about 4 μm to about 12 μm.

5. The battery separator of claim 1, wherein the thickness of the polyvinylidene fluoride non-woven fabric is about 12 μm to about 25 μm.

6. The battery separator of claim 1, wherein the weight average molecular weight of the polyvinylidene fluoride non-woven fabric is about 2×10⁵ to about 8×10⁵, and the molecular weight distribution of the polyvinylidene fluoride non-woven fabric is about 2 to about 5.

7. The battery separator of claim 1, wherein the polyvinylidene fluoride non-woven fabric has a mesh diameter of about 50 nm to about 900 nm.

8. A method for preparing a battery separator, comprising steps of:
mixing an ultra-high molecular weight polyethylene, a linear low density polyethylene with a first solvent to obtain a first mixture, and heating and stirring the first mixture to obtain a mixed solution;
coating the mixed solution onto both surfaces of a polyvinylidene fluoride non-woven fabric to obtain a coated film;
stretching the coated film to obtain a stretched film; and
heatsetting the stretched film to obtain the battery separator.

9. The method of claim 8, wherein the step of heatsetting comprises:
crosslinking the stretched film by radiation to obtain a radiated film; and
heatsetting the radiated film to obtain the battery separator.

10. The method of claim 9, wherein a sensitizer is added during the crosslinking, and the sensitizer is at least one selected from a group consisting of silicon dichloride, carbon tetrachloride, trimethylolpropane trimethacrylate, trimethylolpropane triacrylate and triallyl isocyanurate.

11. The method of claim 9, wherein crosslinking is radiated by at least one selected from a group consisting of a λ ray, an x ray and an electron beam, and the dose of the radiation is about 100 kGy to about 400 kGy.

12. The method of claim 8, wherein the first solvent is at least one selected from a group consisting of decalin, coal oils, benzene, toluene, chloroform, diethyl ether, trichloroethylene, paraffins and liquid paraffins.

13. The method of claim 8, wherein based on the total weight of the mixed solution, the amount of the ultra-high molecular weight polyethylene is about 1 wt % to about 15 wt %, the amount of the linear low density polyethylene is about 0.5 wt % to about 8 wt %, and the amount of the first solvent is about 75 wt % to about 99 wt %.

14. The method of claim 8, wherein the stretching includes low temperature stretching and high temperature stretching, the stretching temperature of low temperature stretching is about 20° C. to about 40° C., and the stretching temperature of high temperature stretching is about 90° C. to about 110° C.

15. The method of claim 8, wherein the polyvinylidene fluoride non-woven fabric is obtained by:
placing a polyvinylidene fluoride in a second solvent to obtain a second mixture, and heating and stirring the second mixture to obtain a polyvinylidene fluoride spinning solution; and
placing the polyvinylidene fluoride spinning solution in a high-voltage electrostatic spinning device for spinning to obtain the polyvinylidene fluoride non-woven fabric.

16. The method of claim 15, wherein based on the total weight of the polyvinylidene fluoride spinning solution, the amount of the polyvinylidene fluoride is about 3 wt % to about 30 wt %, and the amount of the second solvent is about 70 wt % to about 98 wt %; and the second solvent is at least one selected from a group consisting of N, N-dimethylformamide, N-methylpyrrolidone, acetone, dimethylacetamide, dimethyl sulfoxide and tetrahydrofuran.

17. The separator of claim 1, wherein the separator has a porosity of about 40% to about 80%.

18. The separator of claim 1, wherein the separator has an air permeability no less than 235 s/mL.

19. The separator of claim 1, wherein the separator has a puncture strength no less than 0.6 kgf.

20. The separator of claim 1, wherein the polyvinylidene fluoride non-woven fabric has fibers with a diameter of about 50 nm to about 200 nm.
